(19) United States
(12) Patent Application Publication
(10) Pub. No.: US 2009/0162514 A1
(43) Pub. Date: Jun. 25, 2009

(54) Production of pasta using rice bran and rice flour

(76) Inventors: Leo Gingras, Scottsdale, AZ (US); Paul Mathewson, Scottsdale, AZ (US); Rani Madhavapeddi Patel, Phoenix, AZ (US)

Correspondence Address: MCDERMOTT, WILL & EMERY LLP;Attn: IP Department, 227 WEST MONROE STREET, SUITE 4400, CHICAGO, IL, 60606-5096, US

(21) Appl. No.: 12/317,097

(22) Filed: Dec. 19, 2008

Related U.S. Application Data
(60) Provisional application No. 61/016,004, filed on Dec. 21, 2007.

(51) Int. Cl. A23L 1/16

(52) U.S. Cl. 426/557

(57) ABSTRACT

The present invention provides a pasta product wherein a portion of the semolina used in pasta is substituted with stabilized rice bran resulting in a finished product having significantly more dietary fiber.

### CROSS-REFERENCE TO RELATED APPLICATIONS

This application claims priority to U.S. Provisional Application No. 61/016,004, filed Dec. 21, 2007, which is hereby incorporated by reference.

### FEDERALLY SPONSORED RESEARCH OR DEVELOPMENT

Not Applicable.

### TECHNICAL FIELD

This invention relates to food compositions and more particularly, to a pasta product having an improved level of dietary fiber.

### BACKGROUND OF THE INVENTION

Wheat pastes, commonly referred to as pasta, are ubiquitous throughout the world. Pastas are made from a basic mixture of ground wheat endosperm and water, formed into a desired shape and then either immediately consumed or dried for consumption in the future. Worldwide, the consumption of wheat as pasta is more widespread than its use in breadmaking. Thus, it represents a very considerable portion of the world's dietary intake.

The majority of pasta products are made from durum wheat (Triticum durum) semolina though some areas use common bread wheat (Triticum vulgare) flours. Durum wheats are preferred because they are generally very hard wheats with relatively high protein content. In addition, the quality of the protein component is such that a dough can be easily formed when the semolina is mixed with water.

Semolina flour is made up mostly of carbohydrate in the form of starch, protein and very little fat. While not universal, certainly in countries where the technology is available, most pasta is produced using extrusion to heat, mix and form the semolina/water mixture into the wide variety of shapes commonly found on the shelves of grocery stores. The pasta thus produced is rich in highly digestible starch component and has relatively small amount of other non-starch carbohydrate fiber. The percentage of dietary fiber in semolina flour is about 4%. A single serving of pasta is typically about 56 grams (USDA Guideline). Such a serving of pasta provides only about 2 grams of dietary fiber while the recommended adult daily intake of fiber is 25 to 28 grams. The recommended daily intake of fiber for an adult female is 25 grams while the recommended daily intake of fiber for an adult male is 28 grams.

Many studies over the past two decades have strongly suggested that dietary fiber plays an important role in human health. It is now thought that dietary fiber contributes to disease resistance, improved physiological metabolism, and in preventive medicine. Pastas produced using only durum semolina and water do not provide enough fiber to be considered as good sources of that nutrient. Because pasta represents a very popular and heavily consumed source of nutrition throughout the world, improving its overall nutrient content, including its level of fiber, would be highly desirable.

One means of increasing the nutrient content of pasta is to substitute a portion of the semolina flour with a product having a higher fiber component while maintaining the overall quality of the pasta product. The present invention provides a pasta composition having an increased fiber level using stabilized rice bran (SRB) as a substitute for all or a portion of the semolina flour.

### SUMMARY OF THE INVENTION

The present invention substitutes a portion of the semolina used in pasta with a high fiber component, which results in a finished product having significantly more dietary fiber, thus helping the consumer toward the goal of the recommended daily dietary fiber intake. In one embodiment, the present invention provides a pasta product comprising a dough comprising flour and water, wherein the flour comprises SRB in an amount effective to improve the fiber content of the pasta product.

In one embodiment of the present invention, SRB is used as a substitute for a portion of the semolina flour. SRB is composed of approximately 14.5% protein, 20% fat and 30% dietary fiber. The degree of substitution of SRB for semolina depends in part on the amount of dietary fiber desired in the finished product. For illustrative purposes, a substitution of 10% of the semolina flour with SRB would result in approximately 3.0 grams of dietary fiber in each serving as compared to 2.0 grams for the semolina-only formulation.

In another embodiment, the present invention provides a composition incorporating a defatted SRB product in the pasta formulation. Defatted SRB is higher in fiber content compared to full-fat SRB, resulting in a product with a higher level of fiber, while decreasing the overall fat content of the pasta to a level similar to the semolina-only pasta.

In yet another embodiment, the present invention provides a composition incorporating both SRB and rice flour to produce a 100% rice pasta. This product achieves the goal of increased dietary fiber content relative to semolina pasta, while potentially qualifying as “gluten free”, and “hypoallergenic.” The composition may include the defatted form of SRB.

These and other aspects of the invention will become more apparent when read with the detailed description which follows.

### DETAILED DESCRIPTION

Pasta products are conventionally made by forming a paste or dough from flour and water, shaping the dough into a ribbon, cylinder, conduit or some other shape and then cooking the shaped dough. This shaping can be done by using conventional equipment such as an extruder equipped with the appropriate die. If an egg is added to the dough and the dough formed into a ribbon, the finished product is typically referred to as a noodle or egg noodle. Optionally, other ingredients are also added to the dough such as flavoring or coloring. Fresh raw pasta may be cooked using conventional techniques. Alternatively, shaped dough may be dried and packaged for sale.

As discussed, ensuring enough fiber in the human diet has significant positive long-term health effects, including improved Taxation, lowering of serum cholesterol levels, aiding in weight loss, possibly reducing the incidence of some types of cancer, and controlling serum glucose levels. Because current human diets tend to be high in refined foods, the level of fiber consumption may be inadequate for achieving the health benefits associated with fiber consumption.

Generally, semolina-only pasta provides limited nutrition, particularly in terms of fiber content. In a FDA-suggested serving of cooked pasta (56 grams), the dietary fiber contribution of semolina-only pasta is approximately 2 grams. The current daily requirement for dietary fiber, as recommended by FDA guidelines, is 25 grams for an adult female and 28 grams for an adult male. To qualify as a “good” source of fiber for an adult male, a serving must contain from 10% to 19% of the daily recommended amount of dietary fiber. Semolina-only pasta typically does not meet the criteria established for a “good source of fiber” claim. It is desirable to formulate the pasta in such a way that the fiber content is significantly increased per serving thereby achieving a product closer to the dietary guidelines for fiber intake recommended by health professionals.

The present invention describes the use of SRB and derivatives of stabilized rice bran as a replacement of all or a portion of semolina to increase the fiber content of pasta products. With traditional rice milling methods, an enzyme can render the bran and germ rancid in a matter of hours. During milling, lipase and other hydrolytic enzymes, which exists naturally in the bran layer, come in contact with the bran's oil and begin rapid degradation of the bran. This degradation results in a rice bran with short shell life and, therefore, little commercial value. Without a stabilization process, the powerful array of nutrients including fibers, proteins, vitamins, minerals, phytosterols and antioxidants present in rice bran are unavailable because the rancid rice bran is unpalatable. Stabilization of rice bran can be accomplished by many known methods such as heat treatment, mechanical extrusion, and treatment with antilipase enzymes. Stabilized rice bran provides an inexpensive source of highly functional fiber.

The SRB may be fully fatted, partially defatted or fully defatted. SRB may be subjected to further processing yielding stabilized rice bran derivatives. SRB along with the germ can be further processed through mechanical milling to yield particles of specific dimensions. Three different categories of stabilized rice brans namely granular SRB, fine SRB, and extra fine SRB are produced through mechanical milling of SRB.

In one embodiment, SRB is substituted for an appropriate portion of the semolina flour in the formulation of a pasta product. SRB has a fiber content of approximately 30% compared to 4% fiber content in semolina flour. The greater fiber content of SRB allows for substitution of a portion of the semolina flour in order to increase the fiber content while maintaining the quality, taste and texture characteristics of the finished pasta product. For example, a substitution of 10% of the semolina with SRB would result in a pasta product having approximately 3.0 grams of dietary fiber per serving. This product would easily meet the requirements as a “good source of fiber,” and may increase its value to health-conscious consumers. The amount of semolina flour substituted with SRB depends on the desired fiber content and the quality of the finished pasta product. It is possible to utilize SRB in a pasta formulation in which semolina flour is replaced by as little as 1% SRB to as much as 50% SRB, but preferably between 4% and 30% w/w of SRB.

SRB and its derivatives are disclosed in the following commonly owned U.S. patents including: U.S. Pat. No. 5,985,344, issued Nov. 16, 1999, entitled, “Process for Obtaining Micronutrient Enriched Rice Bran Oil;” U.S. Pat. No. 6,126,943, issued Oct. 3, 2000, and entitled, “Method for Treating Hypercholesterolemia, Hyperlipidemia, and Atherosclerosis;” U.S. Pat. No. 6,303,586 issued Oct. 16, 2001, and entitled “Supportive Therapy for Diabetes, Hyperglycemia and Hypoglycemia;” U.S. Pat. No. 6,350,473, issued Feb. 26, 2002 and entitled “Method for Treating Hypercholesterolemia, Hyperlipidemia, and Atherosclerosis;” U.S. Pat. No. 6,558,714, issued May 6, 2003, and entitled “Method for Treating Hypercholesterolemia, Hyperlipidemia, and Atherosclerosis;” U.S. Pat. No. 6,733,799 issued May 11, 2004, and entitled “Method for Treating Hypercholesterolemia, Hyperlipidemia, and Atherosclerosis;” and U.S. Pat. No. 6,902,739, issued Jun. 7, 2005, and entitled “Method for Treating Joint Inflammation, Pain, and Loss of Mobility.” Each of the foregoing patents are hereby incorporated by reference.

Consumers typically prefer pasta products having a firm bite. In culinary circles, food with a firm bite is generally referred to as “al dente” and is typical of Italian cuisine. In certain embodiments, by increasing the amount of SRB in the pasta, the pasta can provide and maintain an “al dente” texture after initial cooking and reheating.

In another embodiment of the invention, defatted SRB is substituted for semolina flour in the pasta formulation. Defatting is accomplished by extracting the oils using, for example, an organic solvent by known methods. The oil/solvent solution is then separated from the bran portion resulting in a bran fraction with greatly reduced oil content. The use of regular SRB in a pasta formulation increases the fat content relative to the semolina-only formulation. The use of defatted SRB decreases the fat content of the finished product to a level that more closely mimics the fat content of the semolina-only pasta product. In addition, the fiber content of the defatted SRB is increased proportionately with the removal of the fat, thus providing a product with a higher fiber content and a lower use-rate to achieve the desired fiber content. The substitution rate for defatted SRB may be from about 1% of the semolina flour up to approximately 50% w/w, but is preferably between approximately 3% w/w and 30% w/w of the semolina.

In yet another embodiment, the present invention provides a formulation of a pasta product utilizing a combination of rice flour and SRB to produce pasta products containing only rice components. These pasta products may qualify not only as “good” and/or “excellent” sources of fiber, but also possibly for additional health claims to include “whole grain” “hypoallergenic” and “gluten-free”. The term “whole grain” product is used to refer the product having a composition similar to the intact cereal grain. Whole grain pasta has been formulated and manufactured, specifically, whole grain wheat pasta. However, the sensory qualities of this pasta have been described as having an undesirably strong cooked-wheat flavor, negative appearance and fragile texture. In contrast, the rice-only pasta product has an appearance similar to a normal semolina-based product with a mild agreeable flavor. Pasta products containing only rice components can also be prepared using partially or fully defatted SRB.

Substitution of semolina with SRB at the stated rates can satisfy the requirement for both “good” and “excellent” sources of fiber. For a food composition to be considered as a good source of fiber, it must contain 10 to 19% of the recommended adult daily intake of fiber. For a food composition to be considered as an excellent source of fiber, it must contain 20% or more of the recommended adult daily intake of fiber. The current daily requirement for dietary fiber, as recommended by FDA guidelines, is 25 grams for an adult female and 28 grams for an adult male. In addition to the fiber component, use of SRB in the formulation also increases the fat content, as well as, possibly contributing additional nutrients including a highly digestible protein component and essential micronutrients including vitamins, minerals and phytosterols.

In all such formulations, the methodology for producing the finished pasta product involves the same basic techniques currently utilized and known in the art for semolina-only pasta. That is, the rice component formulation would be combined with water (and other components to influence flavor, texture etc.) and mixed and shaped in an extruder. The extruded product would be dried conventionally.

In certain aspects, the present invention provides a product comprising a dough formed including an SRB-flour component and water. In the case of a pasta product, a whole egg or egg white can be added to the dough. In order to prepare the dough, the dry components may be mixed together until they are uniformly dispersed and then the water and/or egg component is added to the dry mix. Alternatively, all of the ingredients are mixed together at once to form a uniform dough.

The amount of water and/or egg used to form the dough will vary depending on the pasta making method. Generally, the amount of water used is up to about 30% by weight of flour material in the dough. Egg may be an optional ingredient to the pasta formulations. The egg can be added as whole egg or as a combination of water and powdered egg. Other ingredients can be added to the dough such as flavorings, seasonings, coloring, vitamins, minerals, vegetable solids or puree and preservatives, which are typical in the production of pasta as known to those skilled in the art. Dough can then be shaped into conventional or unconventional shapes, cooked immediately or dried for subsequent sale to consumers. Cooking of fresh pasta or dried pasta is typically done through boiling for a specific time required for the various types and shapes of pasta, as is well known in the art. The pasta composition of the present invention can be cooked in the same manner as is known for conventional semolina-only pasta.

Thus, substituting SRB and/or defatted SRB for a portion of semolina flour improves the fiber level and nutritional profile of conventional semolina-only pasta products. In addition, a completely new form of pasta can be formulated using only rice components resulting in products that also meet desirable fiber levels and can potentially be labeled as “good” and “excellent” sources of fiber, as well as, being “hypoallergenic” and “gluten-free”. Such claims provide a desirable marketing advantage and a perception on the part of consumers of a wholesome and nutritious food product.

These and other aspects of the present invention may be more fully understood by reference to the following examples.

### EXAMPLE 1

### Pasta Formulated with Stabilized Rice Bran

This example illustrates making a pasta product in accordance with the present invention. In order to prepare the pasta product, a control containing 454 grams of durum wheat flour and 300 grams of whole egg are used. In order to test the effect of SRB addition on the pasta, a test sample is made using 454 grams of flour mixture containing approximately 136 grams (30% W/W) of stabilized rice bran and approximately 318 grams of (70% w/w) durum wheat flour in place of 454 grams of pure durum wheat flour.

In making the pasta, approximately 454 grams of durum wheat flour (control), or a blend of SRB and flour (example according to the present invention) is placed into a bowl and a well is formed in the center. Into the well, 300 grams of egg are added and mixed slowly with a fork until moist to obtain a rough dough. The dough is then removed from the bowl and kneaded by hand on a tabletop surface until a uniform texture and color is achieved.

The pasta dough is then formed into a dough ball and the dough ball is cut into thirds using a knife. The dough is then passed through a pasta machine. During the first pass the dough is folded in thirds, slightly dusted, and run through until a smooth dough sheet results. The dough sheet is then run through the machine at successively fine, higher settings. After the fifth level the dough sheet is cut in half with a knife and each is run through the sixth level. The dough sheets is slightly dusted with durum wheat flour and run through eleven ¼″ pasta blades to form the final noodle product. The pasta noodles are then separated and air dried, overnight, at room temperature. The pasta is then cooked by adding it to boiling water containing 0.50 grams of salt for 20 minutes. At the end of the cooking, the pasta is drained and rinsed with cold water and tested by a taste panel consisting of five panelists. The panelists found the pasta formulated with stabilized rice bran and cooked up in the normal time frame (15-20 minutes) with acceptable pasta taste, texture and appearance.

### EXAMPLE 2

### Pasta Formulated with Stabilized Rice Bran and Rice Flour

Using the same procedure as outlined in Example 1, five different pasta preparation were made using rice flour and SRB in different proportions as shown in Table 1. Each of these five different pasta preparations were cooked as in Example 1 and subjected to testing by taste panel consisting of five panelists. The panelists found the rice pasta cooked up in the normal time frame (15-20 minutes) with acceptable pasta taste, texture and appearance.

As shown in Table 2, along with pasta preparation with different amounts of SRB, pasta preparations were also made using different proportions of defatted SRB. Table 2 provides the composition, energy level and fiber content of various resulting pasta preparations. These values were calculated using the ESHA Genesis Food Nutrition Program. (Genesis R & D Product Development and labeling Software).

TABLE 1
Relative proportion of stabilized rice bran and rice flour

| Stabilized Rice Bran | Rice Flour |
|---|---|
| 10% (45.4 g) | 90% (408.6 g) |
| 15% (68.1 g) | 85% (385.9 g) |
| 20% (90.8 g) | 80% (363.2 g) |
| 25% (113.5 g) | 75% (340.5 g) |
| 30% (136.2 g) | 70% (317.9 g) |

TABLE 2
Composition of various pasta preparation

| | | | Rice | | | | | | | | | | | | | | | | | |
|---|---|---|---|---|---|---|---|---|---|---|---|---|---|---|---|---|---|---|---|---|
| | Semolina | | Flour | | Rice Flour + | | | | | | | | | | | | | | | |
| Measured | Pasta | | No | | SRB | | | | | | | | Rice Flour + Defatted SRB | | | | | | | |
| parameter | No SRB | | SRB | | 10% | | 15% | | 20% | | 25% | | 10% | | 15% | | 20% | | 25% | |
| Calories | 200 | | 200 | | 200 | | 200 | | 200 | | 200 | | 200 | | 200 | | 200 | | 200 | |
| Fat | 1 | g | 1 | g | 2 | g | 2.5 | g | 3 | g | 3.5 | g | 1 | g | 1 | g | 1 | g | 1 | g |
| Saturated | 0 | | 0 | | 0 | | 0 | | 0.5 | g | 0.5 | g | 0 | | 0 | 0 | | 0 | | |
| Fat | | | | | | | | | | | | | | | | | | | | |
| Total | 42 | g | 45 | g | 43 | g | 42 | g | 42 | g | 41 | g | 44 | g | 43 | g | 43 | g | 42 | g |
| carbohydrate | | | | | | | | | | | | | | | | | | | | |
| Dietary fiber | 2 | g | 1 | g | 3 | g | 4 | g | 4 | g | 5 | g | 4 | g | 5 | g | 6 | g | 7 | g |
| Sugars | 1 | g | 0 | | 0 | | 1 | g | 1 | g | 1 | g | 0 | | 1 | g | 1 | g | 1 | g |
| Protein | 7 | g | 3 | g | 4 | g | 4 | g | 4 | g | 5 | g | 4 | g | 4 | g | 5 | g | 5 | g |

### EXAMPLE 3

### Lasagna Noodles Formulated with Stabilized Rice Bran

Using the same procedure as outlined in Example 1, about 454 grams of a dough is formed and lasagna noodles are cut from the dough. Formed noodles are frozen for seven days. Using the frozen noodles and a conventional meat sauce and cheese, a lasagna is made using the noodles and is cooked in a conventional oven in a conventional manner.

All publications, patents and patent applications mentioned in this specification are herein incorporated by reference into the specification in their entirety for all purposes. As will be apparent to persons skilled in the art, modifications and adaptations to the above-described invention can be made without departing from the spirit and scope of the invention, which is defined and circumscribed by the appended claims.

What is claimed is:

1. A pasta product comprising a flour and stabilized rice bran in an amount sufficient to provide at least a portion of the recommended daily allowance of fiber in the pasta product.

2. The pasta product of claim 1, wherein the amount of the stabilized rice bran is in the range of about 3% to about 50% by weight of flour material.

3. The pasta product of claim 1, wherein the amount of the stabilized rice bran is in the range of about 10% to about 40% by weight of flour material.

4. The pasta product of claim 1, wherein the amount of the stabilized rice bran is in the range of about 3% to about 30% by weight of flour material.

5. The pasta product of claim 1, wherein the flour material is a rice flour.

6. The pasta product of claim 1, wherein the flour material is a wheat flour.

7. The pasta product of claim 1, wherein the product has an amount of fiber ranging from about 3% (w/w) to about 18% (w/w).

8. A pasta product comprising a flour and a defatted stabilized rice bran in an amount sufficient to provide at least a portion of the recommended daily allowance of fiber in the pasta product.

9. The pasta product of claim 8, wherein the amount of the stabilized rice bran is in the range of about 3% to about 50% by weight of flour material.

10. The pasta product of claim 8, wherein the amount of the stabilized rice bran is in the range of about 10% to about 40% by weight of flour material.

11. The pasta product of claim 8, wherein the amount of the stabilized rice bran is in the range of about 3% to about 30% by weight of flour material.

12. The pasta preparation of claim 8, wherein the flour material is wheat flour.

13. The pasta preparation of claim 8, wherein the flour material is rice flour.

14. The pasta product of claim 8, wherein the product has an amount of fiber ranging from about 3% (w/w) to about 18% (w/w).
